(19) United States
(12) Patent Application Publication
(10) Pub. No.: US 2021/0050692 A1
(43) Pub. Date: Feb. 18, 2021

(54) PLUG CONNECTOR

(71) Applicant: Molex, LLC, Lisle, IL (US)

(72) Inventors: Hui-Hsuan YANG, New Taipei City (TW); Yen-Lin CHEN, New Taipei City (TW); Chen-Min LIN, New Taipei City (TW)

(73) Assignee: Molex, LLC, Lisle, IL (US)

(21) Appl. No.: 16/985,224

(22) Filed: Aug. 5, 2020

(30) Foreign Application Priority Data
Aug. 12, 2019 (CN) 201921302938.3

(51) Int. Cl. H01R 13/6591; H01R 13/6581

(52) U.S. Cl. CPC H01R 13/6591; H01R 13/6581

(57) ABSTRACT

The present disclosure provides a plug connector adapted to insert into a receptacle connector, the receptacle connector includes a cage having an opening. The plug connector includes a metal shell and a conductive elastic member. The metal shell is provided with a recessed groove. The conductive elastic member includes a conductive elastic body, the conductive elastic body has a holding portion held in the recessed groove and a first electromagnetic shielding portion extending out of the recessed groove from the holding portion, when the plug connector is inserted forwardly into the receptacle connector, the first electromagnetic shielding portion enters into the opening of the cage of the receptacle connector and mechanically and electrically contacts the cage and the metal shell. However, some embodiments may not include a holding portion or recessed groove.

### RELATED APPLICATION

This application claims priority to Chinese Application Serial No. 201921302938.3, filed on Aug. 12, 2019, which is incorporated by reference in its entirety.

### TECHNICAL FIELD

The present disclosure relates to a plug connector, particularly relates to a plug connector with a conductive elastic member for shielding electromagnetic interference.

### BACKGROUND

Chinese utility model patent application issuance publication No. CN205595559U discloses a plug connector whose EMI gasket is made of a conductive plastic, the conductive plastic has the characteristics of good conductivity, anti-static electricity property, high structural strength, resistance to aging, low production cost, easy processing and good EMI (Electromagnetic Interference) protection function and the like. The EMI gasket includes a plurality of side edges and a through hole enclosed by the side edges, an area of the through hole is smaller than a cross-sectional area of a body portion of a metal shell. The EMI gasket is sheathed rearwardly on an insertion portion of the metal shell, each side edge presses against the body portion, an inner edge of the each side edge is engaged with the insertion portion with interference fit, an outer edge of the each side edge protrudes from a peripheral surface of the body portion. When the plug connector is mated with the receptacle connector, a mating portion of a circuit board is inserted into a corresponding insertion hole of the receptacle connector following the insertion portion of the metal shell, and each side edge of the EMI gasket shields the insertion hole from outside and seals a gap between the plug connector and the insertion hole of the receptacle connector to prevent EMI leakage. However, when the plug connector is mated with the receptacle connector, the gap still exists between an inner side surface of the insertion hole of the receptacle connector and an outer side surface of the plug connector, furthermore, the EMI mainly affects the top portion and the bottom portion of the plug connector, and has little effect on both side portions under general case, although each side edge of the EMI gasket shields the insertion hole from outside, the EMI gasket is made of conductive plastic, whose material is harder, it is practically difficult to make all side edges of the EMI gasket compliantly contact the edge of the insertion hole, especially to the top portion and the bottom portion of the plug connector, so it is easy to produce pores that cause EMI leakage.

United States patent application issuance publication No. U.S. Pat. No. 8,622,770B2 discloses a plug connector whose conductive foam physically and electrically contacts an edge of an opening of a cage of the receptacle connector to form sealing which reduces or prevents EMR (Electromagnetic Radiation) leakage from the opening, thereby reducing or preventing EMI (Electromagnetic Interference) from the surrounding devices. However, although the use of the elastic conductive foam can better seal the gap between the plug connector and the receptacle connector, but only using a conductive carrier, can the conductive foam be stably mounted to the shell of the plug connector, however, the structure of the plug connector is more complicated and the production cost is higher due to the conductive carrier.

### SUMMARY

Therefore, an object of the present disclosure is to provide a plug connector which can improve at least one of problems in the prior art.

Accordingly, in some embodiments, a plug connector of the present disclosure is adapted to insert into a receptacle connector, the receptacle connector comprises a cage having an opening. The plug connector comprises a metal shell and a conductive elastic member. The metal shell is provided with a recessed groove. The conductive elastic member comprises a conductive elastic body, the conductive elastic body has a holding portion held in the recessed groove and a first electromagnetic shielding portion extending out of the recessed groove from the holding portion, when the plug connector is inserted forwardly into the receptacle connector, the first electromagnetic shielding portion enters into the opening of the cage of the receptacle connector and mechanically and electrically contacts the cage and the metal shell.

In some embodiments, the conductive elastic body further has a second electromagnetic shielding portion which is positioned behind the first electromagnetic shielding portion, when the plug connector is inserted forwardly into the receptacle connector, the second electromagnetic shielding portion mechanically and electrically contacts an edge of the cage positioned at the opening.

In some embodiments, the metal shell comprises a top portion and a bottom portion, the recessed groove is provided to one of the top portion and the bottom portion.

In some embodiments, the metal shell comprises a top portion and a bottom portion, the recessed groove is provided to one of the top portion and the bottom portion, the metal shell is further provided with another recessed groove provided to the other of the top portion and the bottom portion, the conductive elastic member further comprises another conductive elastic body provided to the another recessed groove.

In some embodiments, the another conductive elastic body has a holding portion held in the another recessed groove and a first electromagnetic shielding portion extending out of the another recessed groove from the holding portion of the another conductive elastic body, when the plug connector is inserted forwardly into the receptacle connector, the first electromagnetic shielding portion of the another conductive elastic body enters into the opening of the cage of the receptacle connector and mechanically and electrically contacts the cage and the metal shell.

In some embodiments, the another conductive elastic body further has a second electromagnetic shielding portion which is positioned behind the first electromagnetic shielding portion of the another conductive elastic body, when the plug connector is inserted forwardly into the receptacle connector, the second electromagnetic shielding portion of the another conductive elastic body mechanically and electrically contacts the edge of the cage positioned at the opening.

In some embodiments, the conductive elastic member further comprises two side conductive elastic bodies which are respectively connected to two ends of the conductive elastic bodies.

In some embodiments, each side conductive elastic body has a third electromagnetic shielding portion, when the plug connector is inserted forwardly into the receptacle connector, the third electromagnetic shielding portion enters into the opening of the cage of the receptacle connector and mechanically and electrically contacts the cage and the metal shell.

In some embodiments, each side conductive elastic body further has a fourth electromagnetic shielding portion which is positioned behind the third electromagnetic shielding portion, when the plug connector is inserted forwardly into the receptacle connector, the fourth electromagnetic shielding portion mechanically and electrically contacts the edge of the cage positioned at the opening.

In some embodiments, a front end of the first electromagnetic shielding portion has a guiding structure, the guiding structure has a guiding surface which is an oblique surface or an arc surface extending obliquely toward the rear and away from the metal shell.

In some embodiments, the conductive elastic body further has a supporting portion which is positioned behind the second electromagnetic shielding portion of the conductive elastic body and abuts against the metal shell.

In some embodiments, the conductive elastic body further has a supporting portion which is positioned behind the second electromagnetic shielding portion of the conductive elastic body and abuts against the metal shell, and the another conductive elastic body further has a supporting portion which is positioned behind the second electromagnetic shielding portion of the another conductive elastic body and abuts against the metal shell.

In some embodiments, a material of the conductive elastic member is conductive rubber or conductive foam.

Therefore, in some embodiments, a plug connector of the present disclosure is adapted to insert into a receptacle connector, the receptacle connector comprises a cage having an opening. The plug connector comprises a metal shell and a conductive elastic member. The conductive elastic member comprises a conductive elastic body held to the metal shell, the conductive elastic body has a first electromagnetic shielding portion and a second electromagnetic shielding portion positioned behind the first electromagnetic shielding portion, a height of the first electromagnetic shielding portion relative to the metal shell is lower than a height of the second electromagnetic shielding portion relative to the metal shell, when the plug connector is inserted forwardly into the receptacle connector, the first electromagnetic shielding portion enters into the opening of the cage of the receptacle connector and mechanically and electrically contacts the cage and the metal shell, the second electromagnetic shielding portion mechanically and electrically contacts an edge of the cage positioned at the opening.

In some embodiments, the metal shell comprises a top portion and a bottom portion, the conductive elastic body is held to one of the top portion and the bottom portion.

In some embodiments, the metal shell comprises a top portion and a bottom portion, the conductive elastic body is held to one of the top portion and the bottom portion, the conductive elastic member further comprises an another conductive elastic body held to the other of the top portion and the bottom portion.

In some embodiments, the another conductive elastic body has a first electromagnetic shielding portion and a second electromagnetic shielding portion positioned behind the first electromagnetic shielding portion of the another conductive elastic body, a height of the first electromagnetic shielding portion of the another conductive elastic body relative to the metal shell is lower than a height of the second electromagnetic shielding portion of the another conductive elastic body relative to the metal shell, when the plug connector is inserted forwardly into the receptacle connector, the first electromagnetic shielding portion of the another conductive elastic body enters into the opening of the cage of the receptacle connector and mechanically and electrically contacts the cage and the metal shell, the second electromagnetic shielding portion of the another conductive elastic body mechanically and electrically contacts the edge of the cage positioned at the opening.

In some embodiments, the conductive elastic member further comprises two side conductive elastic bodies which are respectively connected to two ends of the two conductive elastic bodies.

In some embodiments, each conductive elastic body has a third electromagnetic shielding portion, when the plug connector is inserted forwardly into the receptacle connector, the third electromagnetic shielding portion enters into the opening of the cage of the receptacle connector and mechanically and electrically contacts the cage and the metal shell.

In some embodiments, each side conductive elastic body further has a fourth electromagnetic shielding portion positioned behind the third electromagnetic shielding portion,

when the plug connector is inserted forwardly into the receptacle connector, the fourth electromagnetic shielding portion mechanically and electrically contacts the edge of the cage positioned at the opening.

In some embodiments, the metal shell is provided with a recessed groove, and the conductive elastic body further has a holding portion held in the recessed groove.

In some embodiments, the metal shell is provided with recessed grooves, the conductive elastic body further has a holding portion held in the corresponding recessed groove, the another conductive elastic body further has a holding portion held in the corresponding recessed groove.

In some embodiments, the conductive elastic bodies further have a supporting portion positioned behind the second electromagnetic shielding portion of the conductive elastic body and abutting against the metal shell.

In some embodiments, the conductive elastic body has a supporting portion positioned behind the second electromagnetic shielding portion of the conductive elastic body and abutting against the metal shell, and the another conductive elastic body further has a supporting portion positioned behind the second electromagnetic shielding portion of the another conductive elastic body and abutting against the metal shell.

In some embodiments of the plug connector of the present disclosure, the gap between the cage and the metal shell is shielded by the conductive elastic member which mechanically and electrically contacts the cage and the metal shell so as to prevent the electromagnetic interference (EMI) from leaking out from the gap. Furthermore, the first electromagnetic shielding portion of the conductive elastic member, which is lower in height and positioned at the front, can enter into the opening of the cage of the receptacle connector and mechanically and electrically contacts the cage and the metal shell, and the second electromagnetic shielding portion, which is higher in height and positioned at the rear, can make the front end thereof mechanically and electrically contact the edge of the cage poisoned at the opening, so that the conductive elastic member has good shield sealing. The conductive elastic member can be stably provided to the plug connector through the engagement of the recessed groove and the holding portion. In addition, the conductive elastic member can also increase the mating stability of the plug connector and the receptacle connector during mating.

### BRIEF DESCRIPTION OF THE DRAWINGS

Other features and technical effects of the present disclosure will be apparent in the embodiments referring to the accompanying figures, in which:

FIG. 1 is a perspective view of a first embodiment of a plug connector of the present disclosure and a receptacle connector, in which the first embodiment has not been inserted into the receptacle connector;

FIG. 2 is a perspective view of the first embodiment and the receptacle connector, in which the first embodiment has been inserted into the receptacle connector;

FIG. 3 is a side view of the first embodiment and the receptacle connector, in which the first embodiment has not been completely inserted into the receptacle connector;

FIG. 4 is a side view of the first embodiment and the receptacle connector, in which the first embodiment has been completely inserted into the receptacle connector;

FIG. 5 is a cross-sectional view of the first embodiment and the receptacle connector, in which the first embodiment has been completely inserted into the receptacle connector;

FIG. 6 is an incomplete partial enlarged view of FIG. 5;

FIG. 7 is a perspective view of the first embodiment;

FIG. 8 is an exploded perspective view of FIG. 7, in which a conductive elastic member of the first embodiment is separated from a metal shell;

FIG. 9 is a side view of the first embodiment;

FIG. 10 is a perspective view of a second embodiment of the plug connector of the present disclosure;

FIG. 11 is an exploded perspective view of FIG. 10, in which a conductive elastic member of the second embodiment is separated from a metal shell;

FIG. 12 is a side view of the second embodiment;

FIG. 13 is a side view of a third embodiment of the plug connector of the present disclosure;

FIG. 14 is an incomplete partial enlarged view of FIG. 13;

FIG. 15 is a side view of a fourth embodiment of the plug connector of the present disclosure;

FIG. 16 is an incomplete partial enlarged view of FIG. 15;

FIG. 17 is a side view of a fifth embodiment of the plug connector of the embodiment disclosure;

FIG. 18 is an incomplete partial enlarged view of FIG. 17;

FIG. 19 is a side view of a sixth embodiment of the plug connector of the present disclosure;

FIG. 20 is an incomplete partial enlarged view of FIG. 19;

FIG. 21 is a side view of a seventh embodiment of the plug connector of the present disclosure;

FIG. 22 is an incomplete partial enlarged view of FIG. 21;

FIG. 23 is a side view of an eighth embodiment of the plug connector of the present disclosure;

FIG. 24 is an incomplete partial enlarged view of FIG. 23;

FIG. 25 is a side view of a ninth embodiment of the plug connector of the present disclosure; and

FIG. 26 is an incomplete partial enlarged view of FIG. 25.

### DETAILED DESCRIPTION OF THE PREFERRED EMBODIEMENTS

Before the present disclosure is described in detail, it should be noted that like elements are denoted by the same reference numerals in the following description.

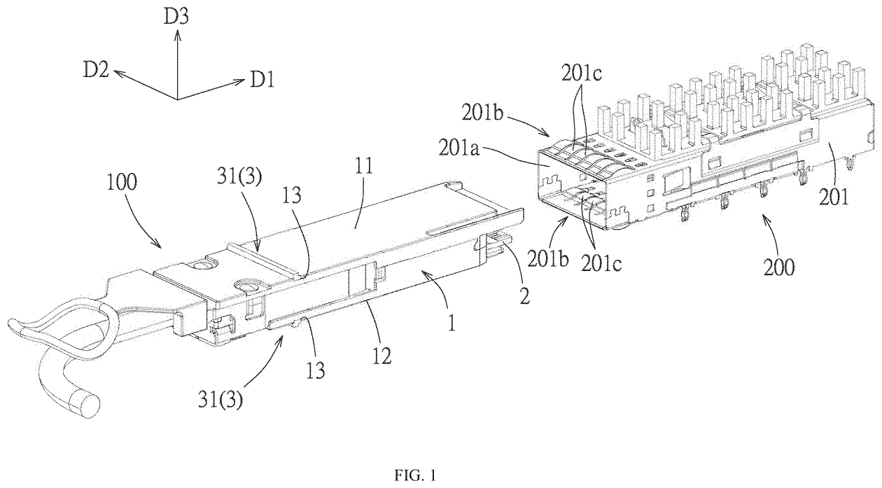

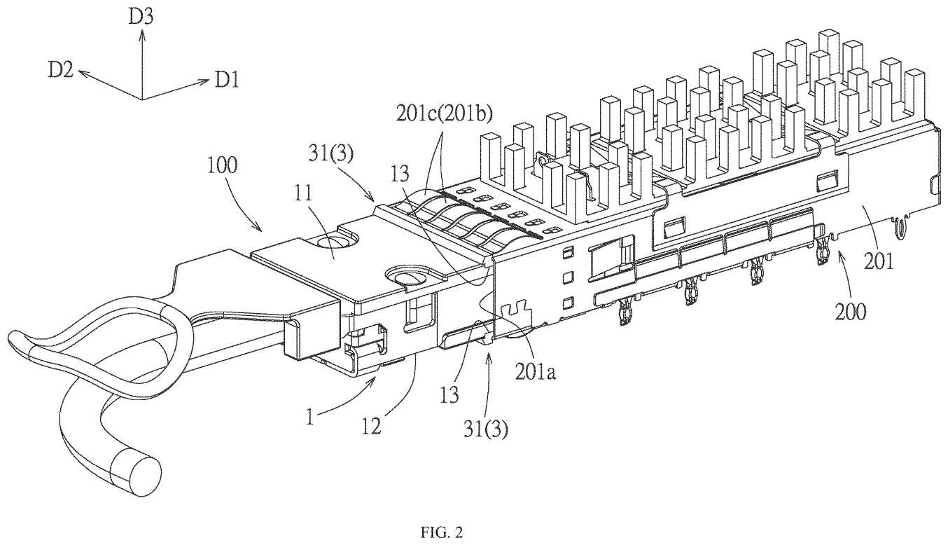

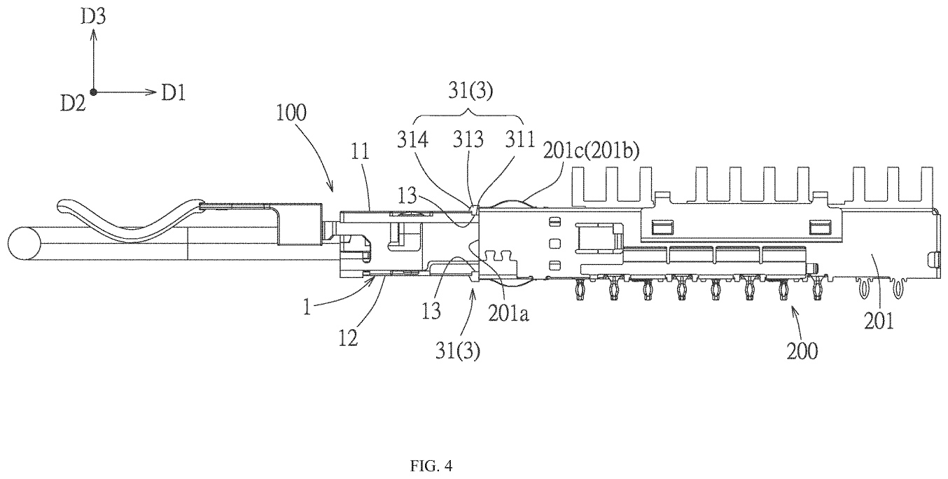

Referring FIG. 1 to FIG. 4, a first embodiment of a plug connector 100 of the present disclosure is adapted to insert into a receptacle connector 200, the receptacle connector 200 includes a cage 201 having an opening 201a and a receptacle module (not shown) provided in the cage 201. Specifically, in the first embodiment, the cage 201 has grounding members 201b provided at upper and lower sides of the opening 201a, the grounding members 201b have a plurality of elastic fingers 201c distributed on an outer side of the cage 201 and an inner side of the cage 201, the elastic finger 201c of the plurality of elastic fingers 201c which is positioned on the outer side of the cage 201 is used to contact a case (not shown), the elastic finger 201c of the plurality of elastic fingers 201c which is positioned on the inner side of the cage 201 is used to contact the plug connector 100, it should be noted that, in other varied embodiments, the plurality of the elastic fingers 201c of the grounding members 201b may also be provided only on the outer side of the cage 201, so the present disclosure is not limited thereto. The plug connector 100 includes a metal shell 1, a mating circuit board 2, and a conductive elastic member 3.

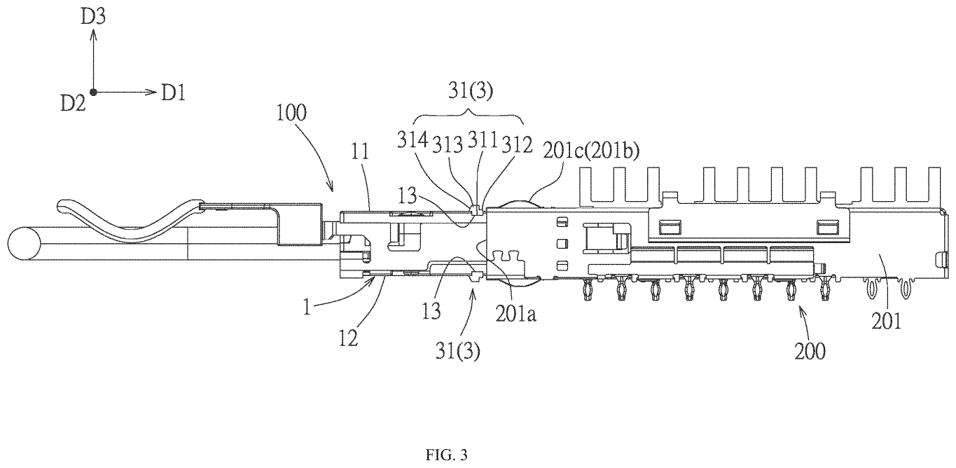

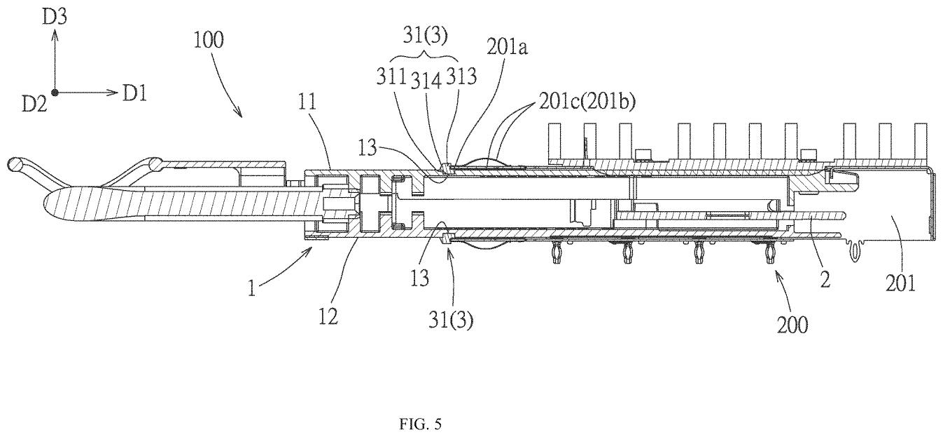

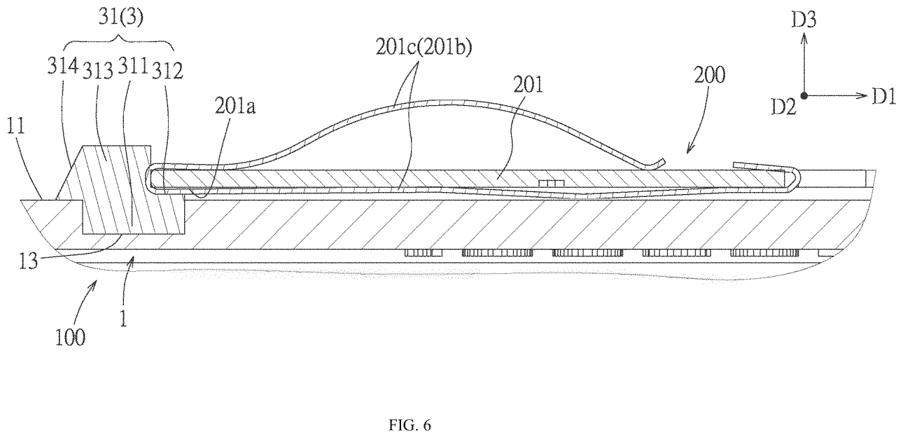

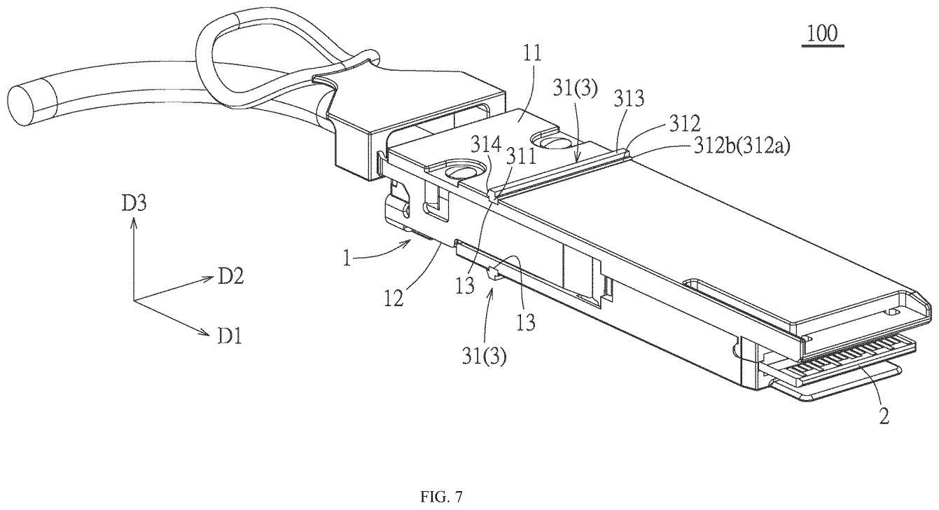

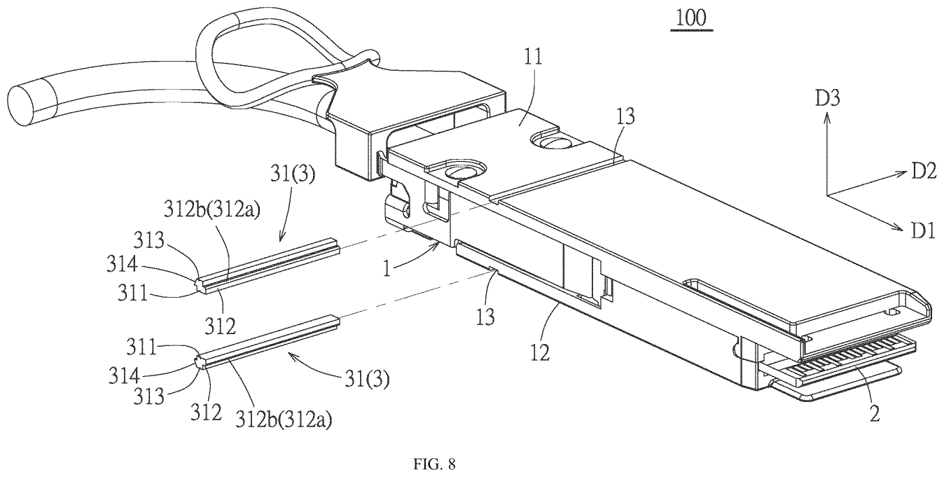

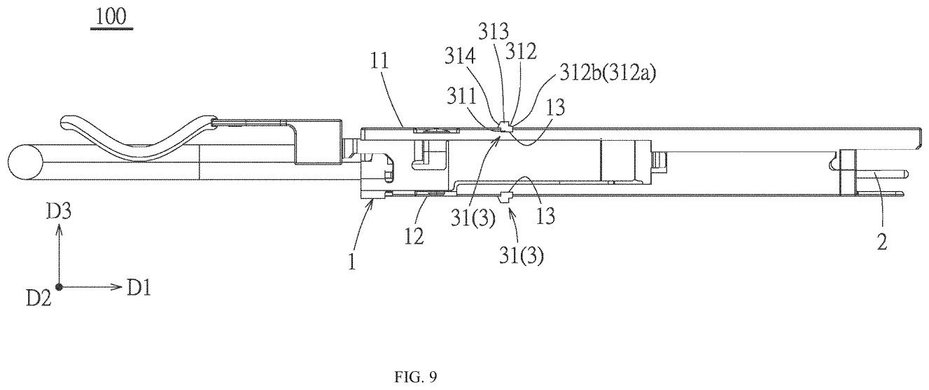

Referring FIG. 3 and FIG. 5 to FIG. 9, the metal shell 1 extends forwardly in a front-rear direction D1 and is used to insert into the cage 201 via the opening 201a. The mating circuit board 2 extends in a left-right direction D2, is embedded and partially exposed in a front end of the metal shell 1, so as to be inserted into and mated with the receptacle module in the cage 201 when the metal shell 1 is inserted forwardly into the cage 201. The metal shell 1 includes a top portion 11 and a bottom portion 12 opposite to each other in an up-down direction D3, and the top portion 11 and the bottom portion 12 of the metal shell 1 each are provided with a recessed groove 13 extending in the left-right direction D2, in the first embodiment, cross sections of the two recessed grooves 13 are rectangular.

A material of the conductive elastic member 3 may be, for example, conductive rubber, conductive foam or other conductive materials with elasticity. The conductive elastic member 3 includes two conductive elastic bodies 31 which extend in the left-right direction D2 and are respectively held in the recessed groove 13 of the top portion 11 and the recessed groove 13 of the bottom portion 12, each conductive elastic body 31 has a holding portion 311 which is held in the corresponding recessed groove 13, a first electromagnetic shielding portion 312 which extends out of the corresponding recessed groove 13 from the holding portion 311, and a second electromagnetic shielding portion 313 which is positioned behind the first electromagnetic shielding portion 312 and connected to the first electromagnetic shielding portion 312 and the holding portion 311, a height of the first electromagnetic shielding portion 312 relative to the metal shell 1 is lower than a height of the second electromagnetic shielding portion 313 relative to the metal shell 1. And in the first embodiment, cross-sections of the holding portion 311, the first electromagnetic shielding portion 312 and the second electromagnetic shielding portion 313 are all rectangular, but the present disclosure is not limited thereto. When the plug connector 100 is inserted forwardly into the receptacle connector 200, the first electromagnetic shielding portion 312 enters into the opening 201a of the cage 201 of the receptacle connector 200 and mechanically and electrically and compressively contacts the cage 201 and the metal shell 1, a front end of the second electromagnetic shielding portion 313 mechanically and electrically and compressively contacts an edge of the cage 201 positioned at the opening 201a. Since the electromagnetic interference (EMI) in general case mainly affects the top portion 11 and the bottom portion 12 of the plug connector 100, with the conductive elastic member 3 which is provided on the top portion 11 and the bottom portion 12 of the metal shell 1 of the plug connector 100 and mechanically and electrically contacts the cage 201 and the metal shell 1, a gap between the cage 201 and the top portion 11 and bottom portion 12 of the metal shell 1 can be shielded, so as to prevent the electromagnetic interference (EMI) from leaking out from the gap. Furthermore, the first electromagnetic shielding portion 312 of the conductive elastic member 3, which is lower in height and positioned at the front, can enter into the opening 201a of the cage 201 of the receptacle connector 200 and mechanically and electrically contact the cage 201 and the metal shell 1, and the second electromagnetic shielding portion 313, which is higher in height and positioned at the rear, can make the front end thereof mechanically and electrically contact the edge of the cage 201 positioned at the opening 201a, so the conductive elastic member 3 has good shield sealing. The conductive elastic member 3 can be stably provided to the plug connector 100 through the engagement of the recessed groove 13 and the holding portion 311. In addition, the conductive elastic member 3 can also increase the mating stability between the plug connector 100 and the receptacle connector 200 during mating. In a variant embodiment, the metal shell 1 may also be provided with one recessed groove 13 extending in the left-right direction D2 only on one of the top portion 11 and the bottom portion 12, and the conductive elastic member 3 may also include only one conductive elastic body 31 extending in the left-right direction D2 and held in the one recessed groove 13, the present disclosure is not limited to the first embodiment.

In addition, the holding portion 311 of each conductive elastic body 31 is provided in the corresponding recessed groove 13 in a manner that the holding portion 311 and the corresponding recessed groove 13 interfere with each other in the front-rear direction D1, so as to strengthen the holding force between the holding portion 311 and the recessed groove 13. It should be noted that, in a variant embodiment, the metal shell 1 is not provided with the recessed groove 13, the conductive elastic body 31 does not have the holding portion 311, and the conductive elastic body 31 of the conductive elastic member 3 is held on the metal shell 1 by, for example, attaching, and in other embodiments, the conductive elastic body 31 can be held on the metal shell 1 in any manner with a sufficient holding force, so the present disclosure is not limited to the first embodiment.

In the first embodiment, the front end of each first electromagnetic shielding portion 312 has a guiding structure 312a, the guiding structure 312a has a guiding surface 312b which is arc surface and extends obliquely toward the rear and away from the metal shell 1, the guiding surface 312b may have, for example, an oblique surface shape, so the present disclosure is not limited to the first embodiment. With the guiding surface 312b extending obliquely, the first electromagnetic shielding portions 312 can more easily enter into the opening 201a of the cage 201 of the receptacle connector 200 when the plug connector 100 is inserted forwardly into the receptacle connector 200. In addition, each conductive elastic body 31 further has a supporting portion 314 which is positioned behind the second electromagnetic shielding portion 313, connected to the second electromagnetic shielding portion 313 and abuts against the metal shell 1. In the first embodiment, a cross section of the supporting portion 314 is a right triangle, two sides of which respectively abuts against the second electromagnetic shielding portion 313 and the metal shell 1, but the present disclosure is not limited thereto. The supporting portion 314 provides a supporting force to the second electromagnetic shielding portion 313, so as to prevent the second electromagnetic shielding portion 313 from turning rearwardly due to the torque generated by the rearward force exerted by the edge of the cage 201 of the receptacle connector 200, thereby further strengthening the structural strength of the conductive elastic body 31.

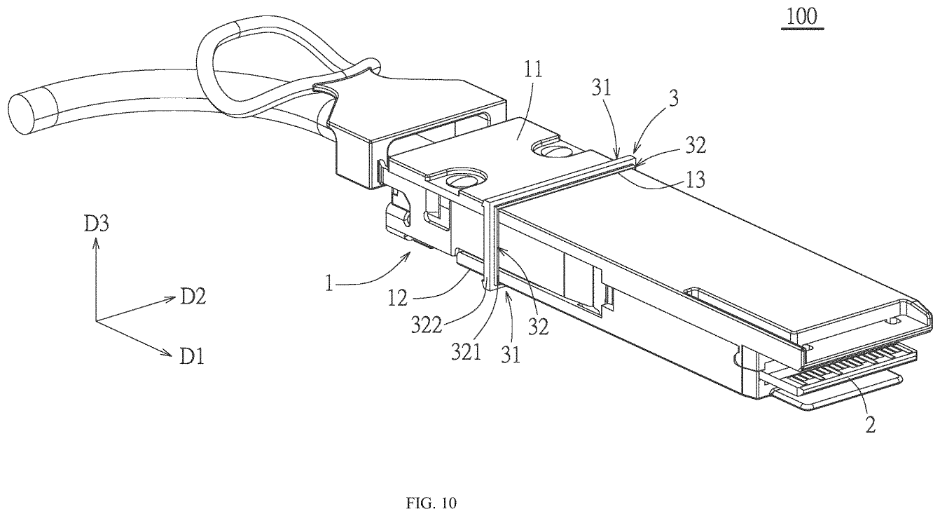

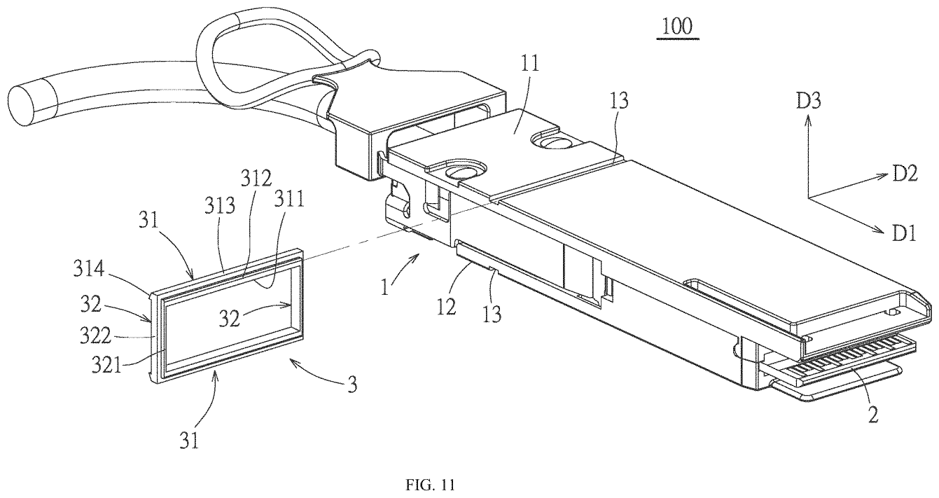

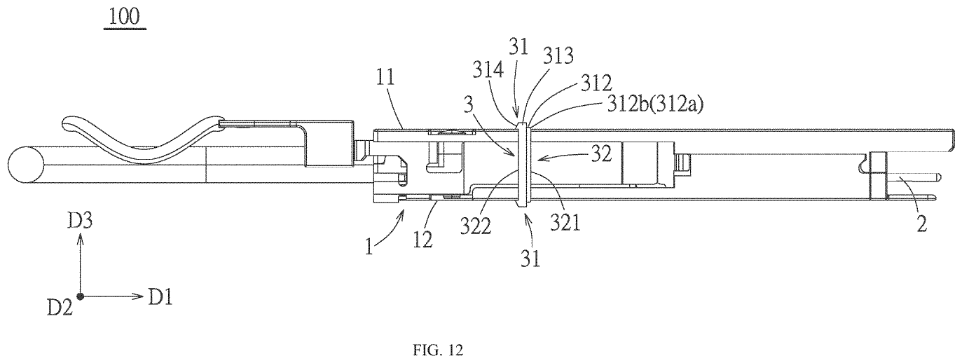

Referring FIG. 10 to FIG. 12, a second embodiment of the plug connector 100 of the present disclosure differs from the first embodiment in that, in the second embodiment, the conductive elastic member 3 further includes two side conductive elastic bodies 32 which extend in the up-down direction D3 and are respectively connected to two ends of the two conductive elastic bodies 31 and respectively abut against both sides of the metal shell 1. Each side conductive elastic body 32 has a third electromagnetic shielding portion 321 and a fourth electromagnetic shielding portion 322 behind the third electromagnetic shielding portion 321, a height of the third electromagnetic shielding portion 321 relative to the metal shell 1 is lower than a height of the fourth electromagnetic shielding portion 322 relative to the metal shell 1. The third electromagnetic shielding portion 321 of the side conductive elastic body 32 is connected between two ends of the first electromagnetic shielding portions 312 of the two conductive elastic bodies 31, and the fourth electromagnetic shielding portion 322 of the side conductive elastic body 32 is connected between two ends of the second electromagnetic shielding portions 313 of the two conductive elastic bodies 31. When the plug connector 100 is inserted forwardly into the receptacle connector 200, the third electromagnetic shielding portion 321 enters into the opening 201a of the cage 201 of the receptacle connector 200 (see FIG. 1) and mechanically and electrically contacts the cage 201 and the metal shell 1, the fourth electromagnetic shielding portion 322 mechanically and electrically contacts the edge of the cage 201 positioned at the opening 201a. The side conductive elastic bodies 32 can improve the shield sealing of the conductive elastic member 3 against the electromagnetic interference (EMI) on the left and right sides, and the side conductive elastic bodies 32 make the conductive elastic member 3 have a ring shape so that the conductive elastic member 3 can be sheathed on the metal shell 1, thereby increasing the holding force between the metal shell 1 and the conductive elastic member 3. In addition, it should be noted that although the connection relationship between the metal shell 1 and the two side conductive elastic bodies 32 is only the relationship of abutting each other in the second embodiment, in a variant embodiment, the metal shell 1 may also be provided with recessed grooves 13 corresponding to the side conductive elastic bodies 32, and the side conductive elastic bodies 32 each may have a holding portion 311 held in the recessed groove 13, so the present disclosure is not limited to the second embodiment.

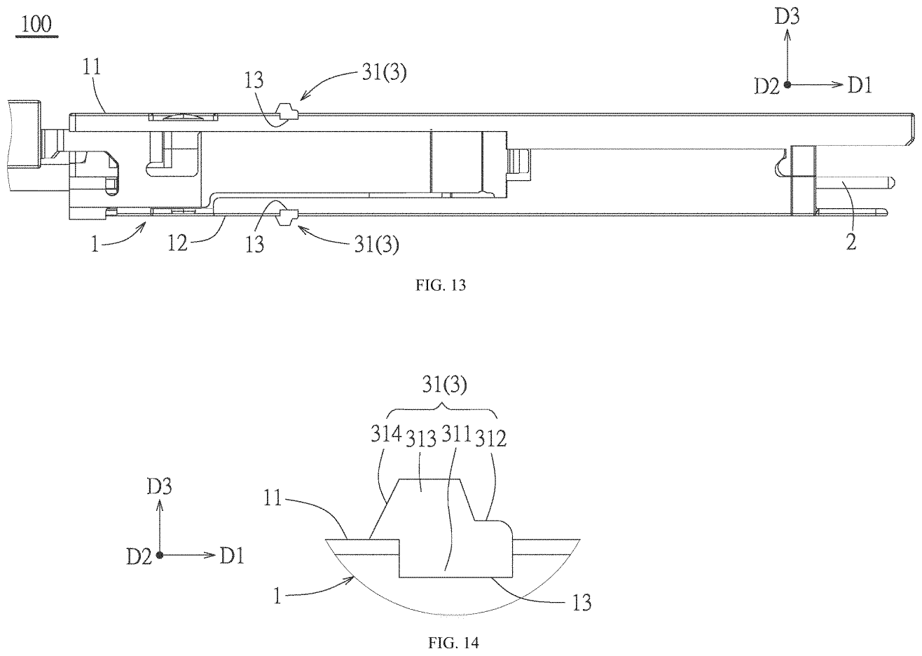

Referring FIG. 13 and FIG. 14, a third embodiment of the plug connector 100 of the present disclosure differs from the first embodiment in that, in the third embodiment, a front end face of the second electromagnetic shielding portion 313 of each conductive elastic body 31 extends obliquely toward the rear and away from the metal shell 1.

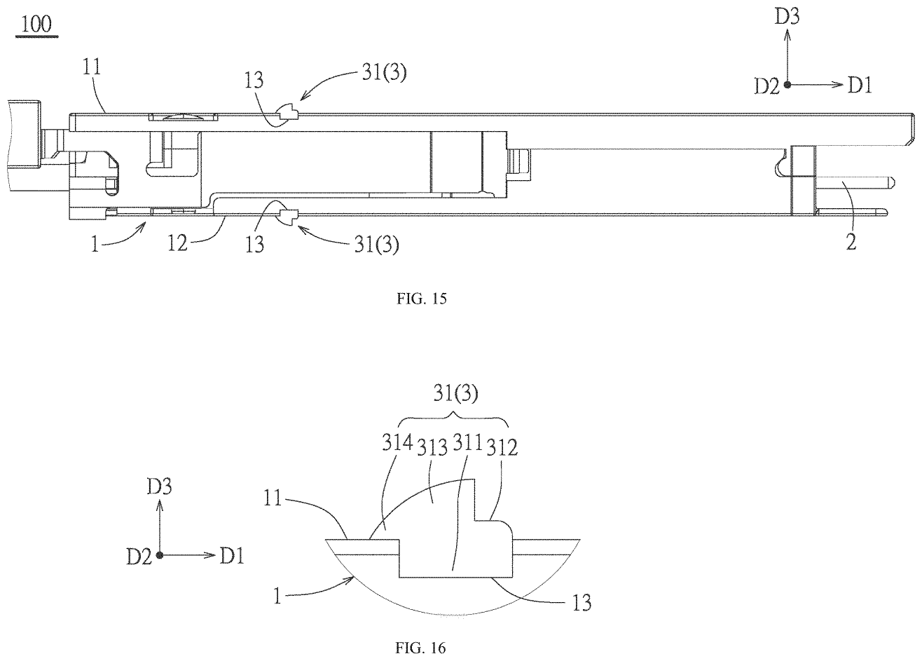

Referring FIG. 15 and FIG. 16, a fourth embodiment of the plug connector 100 of the present disclosure differs from the first embodiment in that, in the fourth embodiment, a top surface of each conductive elastic body 31 is positioned on the second electromagnetic shielding portion 313 and the supporting portion 314 and has an arc shape extending obliquely toward the rear and a direction approaching the metal shell 1.

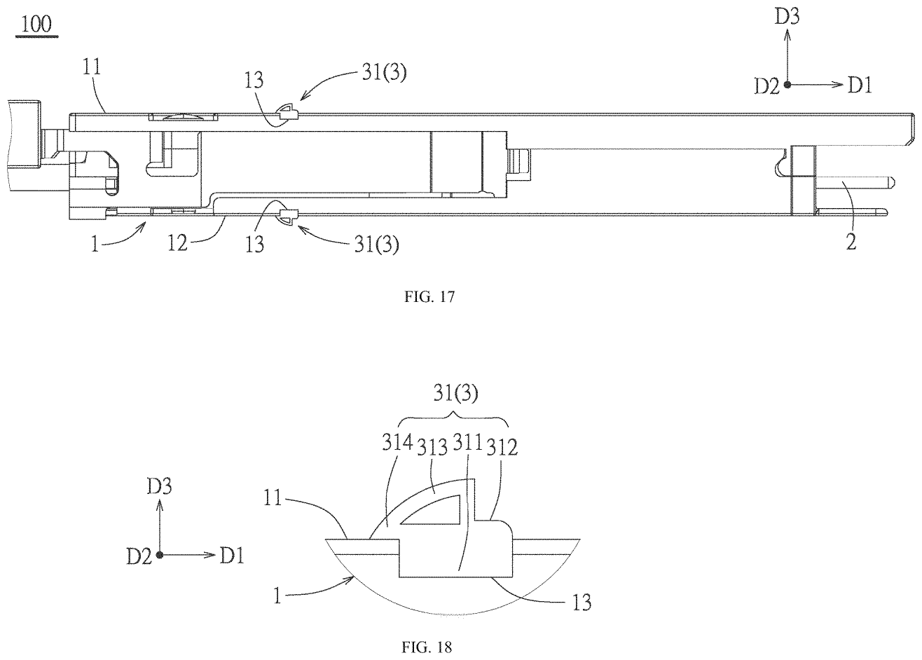

Referring FIG. 17 and FIG. 18, a fifth embodiment of the plug connector 100 of the present disclosure differs from the fourth embodiment in that, in the fifth embodiment, an interior of the second electromagnetic shielding portion 313 of each conductive elastic body 31 is hollow, thereby reducing the used material of the conductive elastic member 3 to save costs.

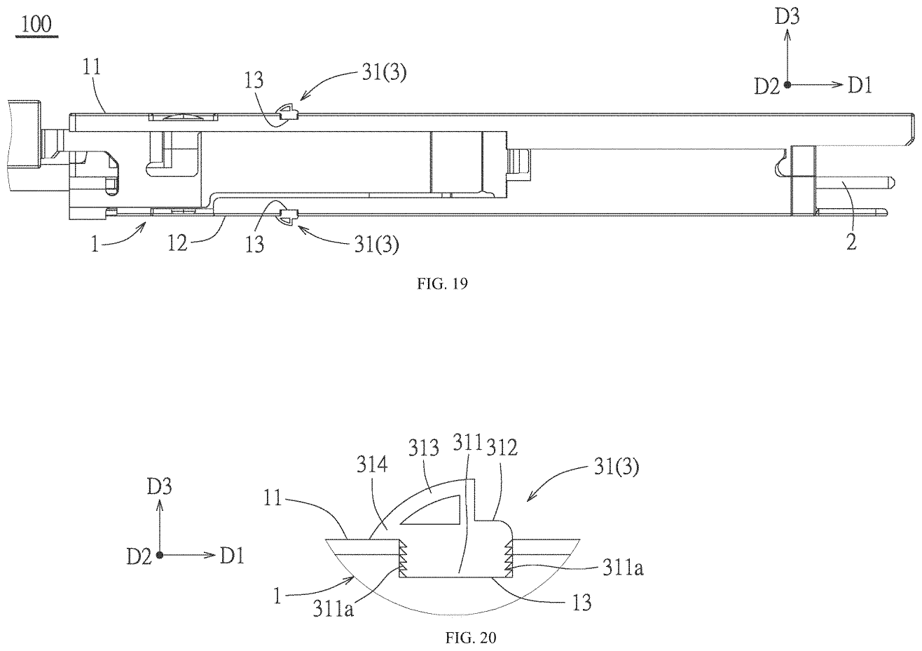

Referring FIG. 19 and FIG. 20, a sixth embodiment of the plug connector 100 of the present disclosure differs from the fifth embodiment in that, in the sixth embodiment, the holding portion 311 of each conductive elastic body 31 has tooth-shape structures 311a which are respectively positioned at a front end and a rear end and are in form of barb shape and interfere with the corresponding recessed groove 13, thereby strengthening the holding force between the holding portion 311 and the recessed groove 13, so as to further prevent the conductive elastic member 3 from falling off from the metal shell 1.

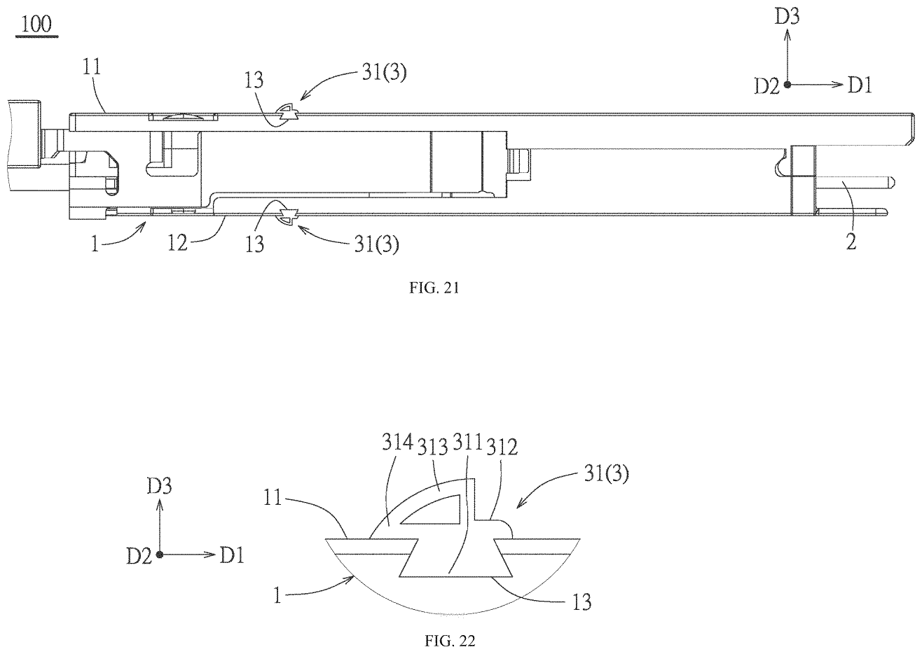

Referring FIG. 21 and FIG. 22, a seventh embodiment of the plug connector 100 of the present disclosure differs from the fifth embodiment in that, in the seventh embodiment, a cross section of the recessed groove 13 of the metal shell 1 and a cross section of the holding portion 311 of the conductive elastic member 3 each are an isosceles trapezoid whose width gradually decreases in a direction away from the metal shell 1. Therefore, the holding force between the holding portion 311 and the recessed groove 13 can be strengthened to further prevent the conductive elastic member 3 from separating from metal shell 1.

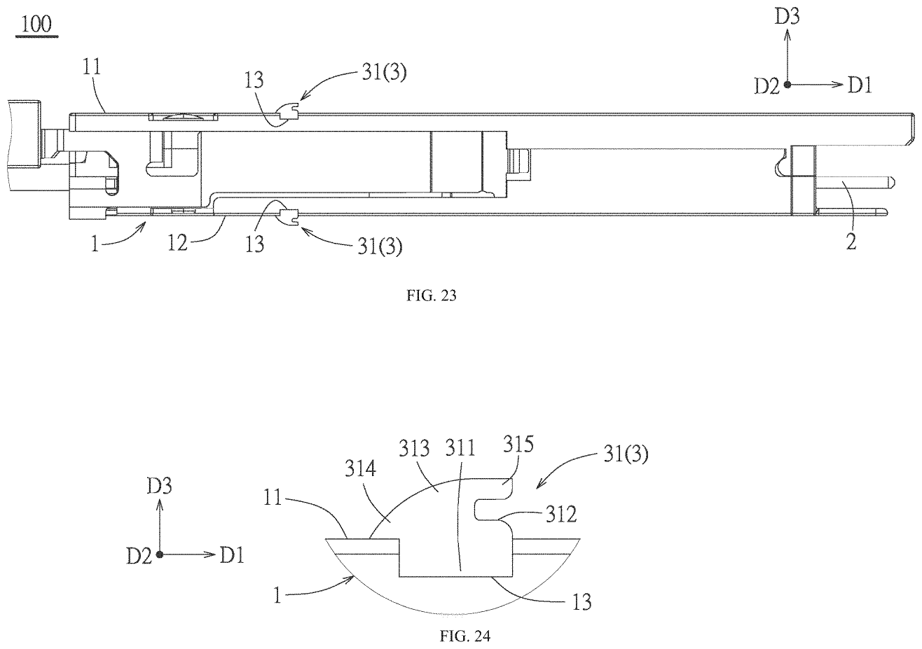

Referring FIG. 23 and FIG. 24, an eighth embodiment of the plug connector 100 of the present disclosure differs from the first embodiment in that, in the eighth embodiment, each conductive elastic body 31 further has a fifth electromagnetic shielding portion 315 connected to a front end of the second electromagnetic shielding portion 313 at a position away from the metal shell 1, the fifth electromagnetic shielding portion 315 covers the edge of the cage 201 when the plug connector 100 is inserted forwardly into the receptacle connector 200, thereby strengthening the shield sealing of the conductive elastic member 3 to the electromagnetic interference (EMI).

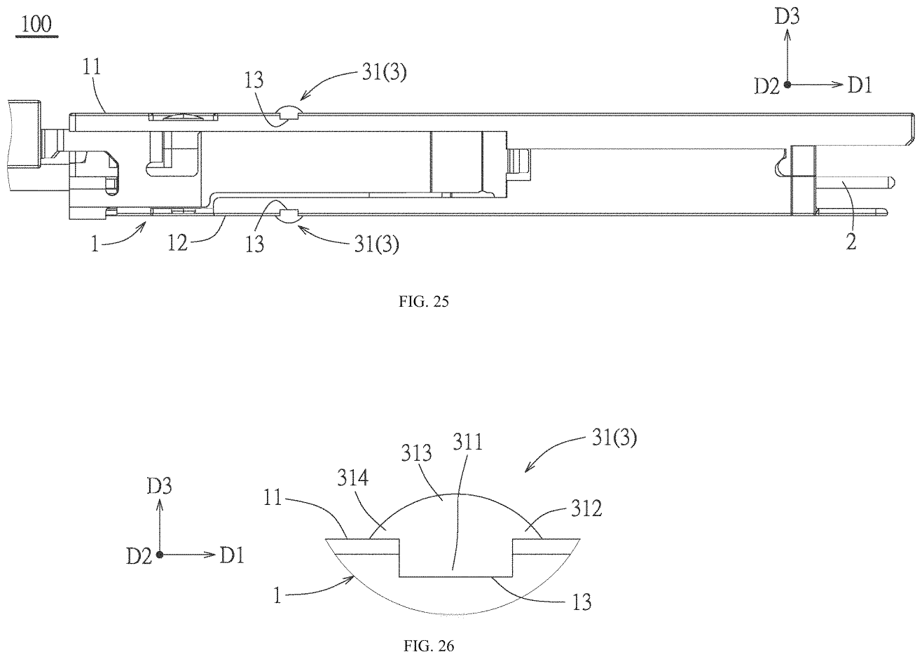

Referring FIG. 25 and FIG. 26, a ninth embodiment of the plug connector 100 of the present disclosure differs from the first embodiment in that, in the ninth embodiment, the first electromagnetic shielding portion 312, the second electromagnetic shielding portion 313 and the supporting portion 314 of each conductive elastic body 31 together form a structure with a cross section generally as a part of a circle.

In conclusion, in the plug connector 100 of the present disclosure, the gap between the cage 201 and the metal shell 1 is shielded by the conductive elastic member 3 which mechanically and electrically contacts the cage 201 and the metal shell 1 so as to prevent the electromagnetic interference (EMI) from leaking out from the gap. Furthermore, the first electromagnetic shielding portion 312 of the conductive elastic member 3, which is lower in height and positioned at the front, can enter into the opening 201a of the cage 201 of the receptacle connector 200 and mechanically and electrically contacts the cage 201 and the metal shell 1, and the second electromagnetic shielding portion 313, which is higher in height and positioned at the rear, can make the front end thereof mechanically and electrically contact the edge of the cage 201 poisoned at the opening 201a, so that the conductive elastic member 3 has good shield sealing. The conductive elastic member 3 can be stably provided to the plug connector 100 through the engagement of the recessed groove 13 and the holding portion 311. In addition, the conductive elastic member 3 can also increase the mating stability of the plug connector 100 and the receptacle connector 200 during mating.

However, the above description is only for the embodiments of the present disclosure, and it is not intended to limit the implementing scope of the present disclosure, and the equivalent changes and modifications made according to the claims and the contents of the specification are still included in the scope of the present disclosure.

What is claimed is:

1. A plug connector configured to be inserted into a receptacle connector with a cage having an opening, the plug connector comprising:
a metal shell provided with a recessed groove; and
a conductive elastic member comprising a conductive elastic body, the conductive elastic body having a holding portion held in the recessed groove and a first electromagnetic shielding portion extending out of the recessed groove from the holding portion, the first electromagnetic shielding portion being in mechanical and electrical contact with the metal shell and a cage of a receptacle connector, when the plug connector has been fully inserted into an opening of the cage.

2. The plug connector of claim 1, wherein
the conductive elastic body further has a second electromagnetic shielding portion which is positioned behind the first electromagnetic shielding portion,
when the plug connector is inserted fully into the receptacle connector, the second electromagnetic shielding portion mechanically and electrically contacts an edge of the cage positioned at the opening.

3. The plug connector of claim 2, wherein
the metal shell comprises a top portion and a bottom portion, the recessed groove is provided to one of the top portion and the bottom portion.

4. The plug connector of claim 2, wherein
the metal shell comprises a top portion and a bottom portion,
the recessed groove is provided to one of the top portion and the bottom portion,
the metal shell is further provided with another recessed groove provided to the other of the top portion and the bottom portion,
the conductive elastic member further comprises another conductive elastic body provided to the another recessed groove.

5. The plug connector of claim 4, wherein
the another conductive elastic body has a holding portion held in the another recessed groove and a first electromagnetic shielding portion extending out of the another recessed groove from the holding portion of the another conductive elastic body,
when the plug connector is inserted fully into the receptacle connector, the first electromagnetic shielding portion of the another conductive elastic body has entered into the opening of the cage of the receptacle connector and is mechanically and electrically contacting the cage and the metal shell.

6. The plug connector of claim 5, wherein
the another conductive elastic body further has a second electromagnetic shielding portion which is positioned behind the first electromagnetic shielding portion of the another conductive elastic body,
when the plug connector is inserted fully into the receptacle connector, the second electromagnetic shielding portion of the another conductive elastic body is mechanically and electrically contacting the edge of the cage positioned at the opening.

7. The plug connector of claim 6, wherein
the conductive elastic member further comprises two side conductive elastic bodies which are respectively connected to two ends of the conductive elastic bodies.

8. The plug connector of claim 7, wherein
each side conductive elastic body has a third electromagnetic shielding portion,
when the plug connector is inserted fully into the receptacle connector, the third electromagnetic shielding portion has entered into the opening of the cage of the receptacle connector and is mechanically and electrically contacting the cage and the metal shell; and further
wherein each side conductive elastic body further has a fourth electromagnetic shielding portion which is positioned behind the third electromagnetic shielding portion,
when the plug connector is inserted fully into the receptacle connector, the fourth electromagnetic shielding portion is mechanically and electrically contacting the edge of the cage positioned at the opening.

9. The plug connector of claim 1, wherein
a front end of the first electromagnetic shielding portion has a guiding structure, the guiding structure has a guiding surface which is an oblique surface or an arc surface extending obliquely toward the rear and away from the metal shell.

10. The plug connector of claim 2, wherein
the conductive elastic body further has a supporting portion which is positioned behind the second electromagnetic shielding portion of the conductive elastic body and abuts against the metal shell.

11. The plug connector of claim 6, wherein
the conductive elastic body further has a supporting portion which is positioned behind the second electromagnetic shielding portion of the conductive elastic body and abuts against the metal shell, and
the another conductive elastic body further has a supporting portion which is positioned behind the second electromagnetic shielding portion of the another conductive elastic body and abuts against the metal shell.

12. The plug connector of claim 1, wherein
a material of the conductive elastic member is conductive rubber or conductive foam.

13. A plug connector configured to be inserted into a receptacle connector with a cage having an opening, the plug connector comprising:
a metal shell; and
a conductive elastic member comprising a conductive elastic body held to the metal shell, the conductive elastic body having a first electromagnetic shielding portion and a second electromagnetic shielding portion positioned behind the first electromagnetic shielding portion, a height of the first electromagnetic shielding portion relative to the metal shell being lower than a height of the second electromagnetic shielding portion relative to the metal shell, the first electromagnetic shielding portion being in mechanical and electrical contact with the metal shell and a cage of a receptacle connector, when the plug connector has been fully inserted into an opening of the cage, and the second electromagnetic shielding portion being in mechanical and electrical contact with an edge of the cage positioned at the opening.

14. The plug connector of claim 13, wherein
the metal shell comprises a top portion and a bottom portion, the conductive elastic body is held to one of the top portion and the bottom portion.

15. The plug connector of claim 13, wherein
the metal shell comprises a top portion and a bottom portion,
wherein the conductive elastic body is held to one of the top portion and the bottom portion,
wherein the conductive elastic member further comprises another conductive elastic body held to the other of the top portion and the bottom portion, and
wherein the another conductive elastic body has a first electromagnetic shielding portion and a second electromagnetic shielding portion positioned behind the first electromagnetic shielding portion of the another conductive elastic body, a height of the first electromagnetic shielding portion of the another conductive elastic body relative to the metal shell is lower than a height of the second electromagnetic shielding portion of the another conductive elastic body relative to the metal shell,
and when the plug connector is inserted forwardly into the receptacle connector, the first electromagnetic shielding portion of the another conductive elastic body enters into the opening of the cage of the receptacle connector and mechanically and electrically contacts the cage and the metal shell, the second electromagnetic shielding portion of the another conductive elastic body mechanically and electrically contacts the edge of the cage positioned at the opening.

16. The plug connector of claim 15, wherein
the conductive elastic member further comprises two side conductive elastic bodies which are respectively connected to two ends of the two conductive elastic bodies;
wherein each conductive elastic body has a third electromagnetic shielding portion and when the plug connector is inserted forwardly into the receptacle connector, the third electromagnetic shielding portion enters into the opening of the cage of the receptacle connector and mechanically and electrically contacts the cage and the metal shell; and
wherein each side conductive elastic body further has a fourth electromagnetic shielding portion positioned behind the third electromagnetic shielding portion and when the plug connector is inserted forwardly into the receptacle connector, the fourth electromagnetic shielding portion mechanically and electrically contacts the edge of the cage positioned at the opening.

17. The plug connector of claim 13, wherein
the metal shell is provided with a recessed groove,
the conductive elastic body further has a holding portion held in the recessed groove.

18. The plug connector of claim 15, wherein
the metal shell is provided with recessed grooves,
the conductive elastic body further has a holding portion held in the corresponding recessed groove,
the another conductive elastic body further has a holding portion held in the corresponding recessed groove.

19. The plug connector of claim 13, wherein
the conductive elastic bodies further have a supporting portion positioned behind the second electromagnetic shielding portion of the conductive elastic body and abutting against the metal shell.

20. The plug connector of claim 15, wherein
the conductive elastic body has a supporting portion positioned behind the second electromagnetic shielding portion of the conductive elastic body and abutting against the metal shell, and
the another conductive elastic body further has a supporting portion positioned behind the second electromagnetic shielding portion of the another conductive elastic body and abutting against the metal shell.
